(19) United States
(12) Patent Application Publication
(10) Pub. No.: US 2020/0337816 A1
(43) Pub. Date: Oct. 29, 2020

(54) PORTABLE ORAL IRRIGATOR

(71) Applicant: Tsai-I HUNG, Nantou County (TW)

(72) Inventor: Tsai-I HUNG, Nantou County (TW)

(21) Appl. No.: 16/392,653

(22) Filed: Apr. 24, 2019

(51) Int. Cl. A61C 17/02; A61C 17/024

(52) U.S. Cl. CPC A61C 17/0202; A61C 19/02; A61C 17/024

(57) ABSTRACT

A portable oral irrigator includes: a foldable container made of a flexible material and having a bottom wall, a peripheral wall connected to the bottom wall, and a receiving space defined jointly by the bottom wall and the peripheral wall, wherein the peripheral wall is circumferentially and concavely provided with a folding groove; a main unit connected to the bottom wall and having a water inlet tube in communication with the receiving space; and a nozzle unit having a connecting tube in communication with the water inlet tube and a nozzle connected to the connecting tube. The peripheral wall can be folded, and the nozzle unit can be received in the collapsed space defined jointly by the folded peripheral wall and the bottom wall, allowing the portable oral irrigator to be carried around with ease.

### BACKGROUND OF THE INVENTION

### 1. Technical Field

The present invention generally falls within the technical field of commercially available oral irrigators. More particularly, the invention relates to a portable oral irrigator.

### 2. Description of Related Art

Referring to FIG. 1, the structure of a conventional oral irrigator mainly includes a machine body 11, a connecting tube 12 in communication with the interior of the machine body 11, and a nozzle 13 in communication with the connecting tube 12. The machine body 11 is provided therein with a receiving space to be filled with water, in order for the water to flow through the connecting tube 12 to the nozzle 13. The nozzle 13 is provided with a pressurizing device. The pressurizing device can pressurize water from the connecting tube 12 and thereby eject the water out of an opening of the nozzle 13 so that the ejected water stream can be used to clean teeth.

As the machine body 11 has a fixed large volume, the oral irrigator cannot be carried around with ease. If, therefore, one who owns such an oral irrigator wants to clean their teeth after eating at a restaurant, for example, they still have to carry a toothbrush with them (in place of the oral irrigator) or simply wash their oral cavity by gargling. In other words, the conventional oral irrigators are not designed to be used wherever and whenever desired.

In view of the above, the inventor of the present invention devoted himself to an extensive research and repeated experiments and finally succeeded in developing a portable oral irrigator as disclosed herein.

### BRIEF SUMMARY OF THE INVENTION

One objective of the present invention is to address the lack of portability of the conventional oral irrigators and provide a novel oral irrigator that can be carried around conveniently.

To achieve the foregoing objective, the present invention provides a portable oral irrigator that includes a foldable container, a main unit, and a nozzle unit.

The foldable container is made of a flexible material and has a bottom wall, a peripheral wall connected to the bottom wall, and a receiving space defined jointly by the bottom wall and the peripheral wall. The peripheral wall is circumferentially and concavely provided with a folding groove.

The main unit is connected to the bottom wall and has a water inlet tube that communicates with the receiving space.

The nozzle unit has a connecting tube and a nozzle. The connecting tube communicates with the water inlet tube, and the nozzle is connected to the connecting tube.

The peripheral wall can be folded so that a collapsed space is defined by the folded peripheral wall and the bottom wall. The collapsed space can be used to receive the nozzle unit.

In a preferred embodiment, the bottom wall is penetrated by a through hole, and the water inlet tube extends through the through hole to communicate with the receiving space.

In a preferred embodiment, the main unit has a first diameter along an extension direction, the peripheral wall has a first peripheral wall portion connected to the bottom wall and a second peripheral wall portion connected to the first peripheral wall portion and having a second diameter along the extension direction, and the bottom wall has a third diameter along the extension direction. The second diameter is greater than the first diameter, but the third diameter is smaller than the first diameter.

In a preferred embodiment, the first peripheral wall portion is connected to the bottom wall on one side and is connected to the second peripheral wall portion on the opposite side, and the first peripheral wall portion is connected to the bottom wall and the second peripheral wall portion in a sloping manner.

In a preferred embodiment, the main unit has a top side peripherally and protrudingly provided with a fixing flange, and the bottom wall is engaged with and surrounded by the fixing flange.

In a preferred embodiment, the main unit is provided with a switch on one side, and the switch can be used to turn on and off the main unit.

In a preferred embodiment, the portable oral irrigator further has a lid for closing the receiving space.

Once the nozzle unit is received in the collapsed space and the collapsed space is closed with the lid, the portable oral irrigator can be carried around conveniently.

### BRIEF DESCRIPTION OF THE SEVERAL VIEWS OF THE DRAWINGS

FIG. 1 is a perspective view of a conventional oral irrigator;

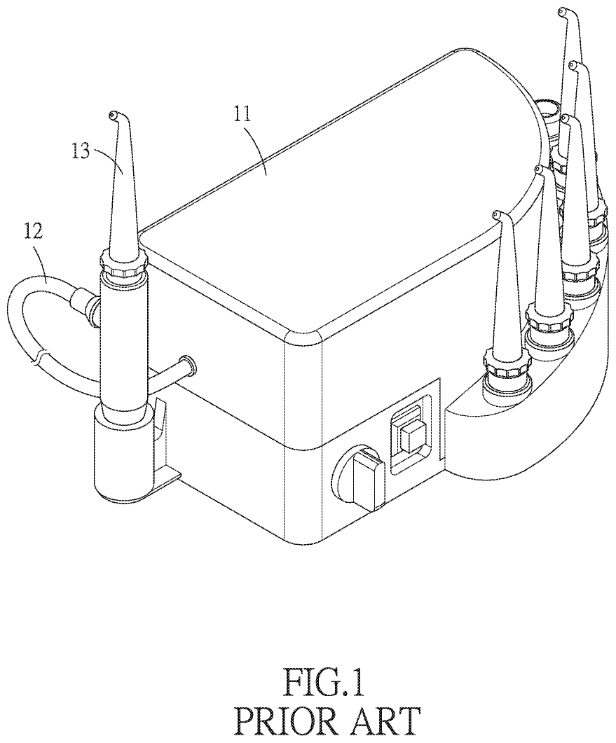

FIG. 2 is a perspective view of a preferred embodiment of the present invention;

FIG. 3 is a sectional view taken along line 3-3 in FIG. 2; and

FIG. 4 is similar to FIG. 3 except that the foldable container is in a folded state.

### DETAILED DESCRIPTION OF THE INVENTION

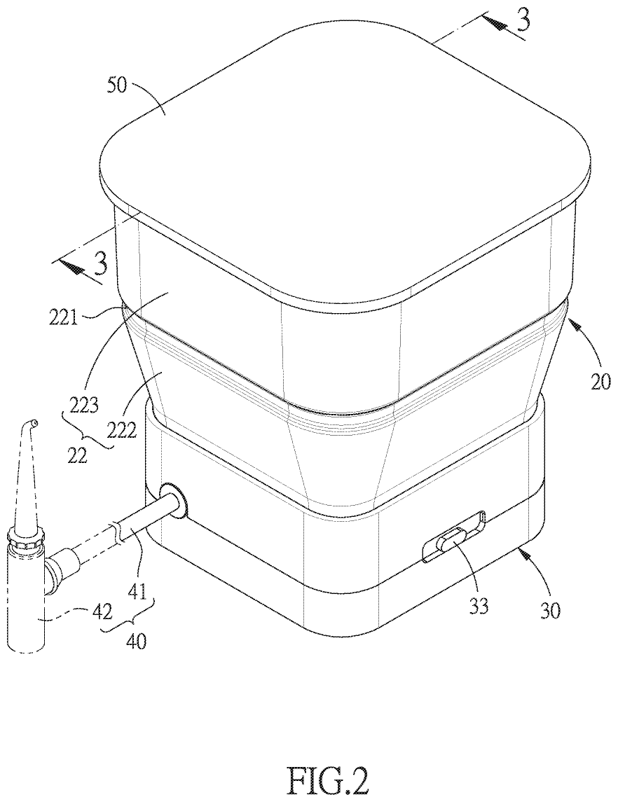

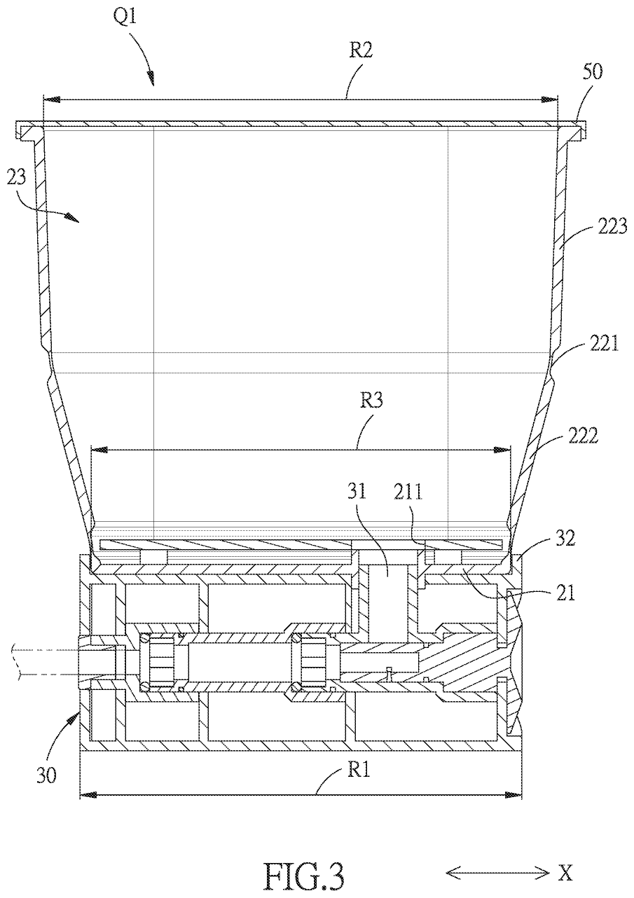

Referring to FIG. 2 and FIG. 3, the portable oral irrigator according to an embodiment of the present invention includes a foldable container 20, a main unit 30, and a nozzle unit 40.

The foldable container 20 is made of a flexible material and has a bottom wall 21, a peripheral wall 22 connected to the bottom wall 21, and a receiving space 23 defined jointly by the bottom wall 21 and the peripheral wall 22. The peripheral wall 22 is circumferentially and concavely provided with a folding groove 221. In this embodiment, the bottom wall 21 is penetrated by a through hole 211.

The main unit 30 is connected to the bottom wall 21 and has a water inlet tube 31 in communication with the receiving space 23. In this embodiment, the water inlet tube 31 extends through the through hole 211 to communicate with the receiving space 23.

The nozzle unit 40 has a connecting tube 41 in communication with the water inlet tube 31 and a nozzle 42 connected to the connecting tube 41.

It should be pointed out that the main unit 30 has a first diameter R1 along an extension direction X, that the peripheral wall 22 has a first peripheral wall portion 222 connected to the bottom wall 21 and a second peripheral wall portion 223 connected to the first peripheral wall portion 222, that the second peripheral wall portion 223 has a second diameter R2 along the extension direction X, that the second diameter R2 is greater than the first diameter R1, that the bottom wall 21 has a third diameter R3 along the extension direction X, and that the third diameter R3 is smaller than the first diameter R1.

Preferably, the first peripheral wall portion 222 is connected to the bottom wall 21 on one side and is connected to the second peripheral wall portion 223 on the opposite side. Due to the difference between the second diameter R2 and the third diameter R3, the first peripheral wall portion 222 is connected to the bottom wall 21 and the second peripheral wall portion 223 in a sloping manner.

Preferably, the top side of the main unit 30 is peripherally and protrudingly provided with a fixing flange 32, and the bottom wall 21 is engaged with and surrounded by the fixing flange 32 to ensure that the foldable container 20 is securely coupled to the main unit 30.

Preferably, a switch 33 is provided on one side of the main unit 30 and can be used to turn on and off the main unit 30.

Preferably, a lid 50 is further provided to close the receiving space 23.

The structural configuration of the illustrated embodiment and the connection between its components have been described above. The following paragraphs disclose how the embodiment is used.

The foldable container 20 has an erected state Q1 and a folded, or collapsed, state Q2.

In the erected state Q1, as shown in FIG. 3, the peripheral wall 22 and the bottom wall 21 jointly define the receiving space 23 so that a user can pour water into the receiving space 23. Once the user turns on the main unit 30 through the switch 33, the water in the receiving space 23 flows into the connecting tube 41 through the water inlet tube 31 and is ejected out of the nozzle 42, allowing the user to clean his or her oral cavity by maneuvering the nozzle 42.

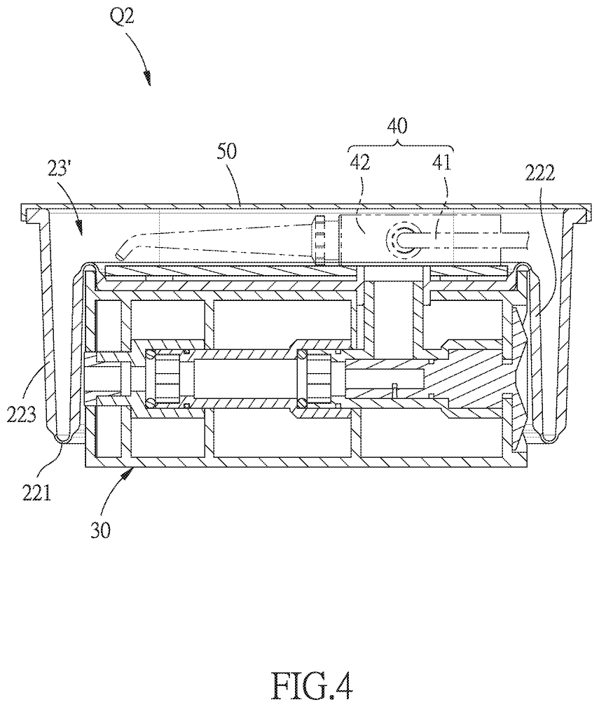

When the cleaning operation is completed, referring to FIG. 4, the second peripheral wall portion 223 can be pushed toward the main unit 30 and, during the process, the first peripheral wall portion 222 will be pushed toward the main unit 30 too, thanks to the flexible material of the foldable container 20. As the second diameter R2 of the second peripheral wall portion 223 is greater than the first diameter R1 of the main unit 30, the second peripheral wall portion 223 will end up surrounding the main unit 30 after the peripheral wall 22 is folded in the foregoing manner.

It should be pointed out that the folded peripheral wall 22 and the bottom wall 21 jointly define a collapsed space 23′ in which the nozzle unit 40 can be received. Once the collapsed space 23′ is closed with the lid 50, the portable oral irrigator can be carried around with ease.

What is claimed is:

1. A portable oral irrigator, comprising:
a foldable container made of a flexible material and having a bottom wall, a peripheral wall connected to the bottom wall, and a receiving space defined jointly by the bottom wall and the peripheral wall, wherein the peripheral wall is circumferentially and concavely provided with a folding groove;
a main unit connected to the bottom wall and having a water inlet tube in communication with the receiving space; and
a nozzle unit having a connecting tube in communication with the water inlet tube and a nozzle connected to the connecting tube;
wherein the peripheral wall is foldable to define, together with the bottom wall, a collapsed space for receiving the nozzle unit.

2. The portable oral irrigator of claim 1, wherein the bottom wall is penetrated by a through hole, and the water inlet tube extends through the through hole to communicate with the receiving space.

3. The portable oral irrigator of claim 1, wherein the main unit has a first diameter along an extension direction, the peripheral wall has a first peripheral wall portion connected to the bottom wall and a second peripheral wall portion connected to the first peripheral wall portion, the second peripheral wall portion has a second diameter along the extension direction, the second diameter is greater than the first diameter, the bottom wall has a third diameter along the extension direction, and the third diameter is smaller than the first diameter.

4. The portable oral irrigator of claim 3, wherein the first peripheral wall portion has a side connected to the bottom wall and an opposite side connected to the second peripheral wall portion, and the first peripheral wall portion is connected to the bottom wall and the second peripheral wall portion in a sloping manner.

5. The portable oral irrigator of claim 1, wherein the main unit has a top side peripherally and protrudingly provided with a fixing flange, and the bottom wall is engaged with and surrounded by the fixing flange.

6. The portable oral irrigator of claim 1, wherein the main unit has a side provided with a switch for turning on and off the main unit.

7. The portable oral irrigator of claim 1, further comprising a lid for closing the receiving space.
